(19) United States
(12) Patent Application Publication
(10) Pub. No.: US 2022/0143722 A1
(43) Pub. Date: May 12, 2022

(54) THREADER AND RETHREADING TOOL

(71) Applicant: David W. Griffin, Bradenton, FL (US)

(72) Inventor: David W. Griffin, Bradenton, FL (US)

(21) Appl. No.: 17/182,793

(22) Filed: Feb. 23, 2021

Related U.S. Application Data
(63) Continuation-in-part of application No. 29/757,971, filed on Nov. 11, 2020.

(51) Int. Cl. B23G 5/06

(52) U.S. Cl. CPC B23G 5/06

(57) ABSTRACT

An elongated threading and rethreading tool (1) having a proximal section (2) for spinning the tool, a cylindrical distal section (3) having a cavity (7) for holding a thread-cutting die (9) and a middle section (4) for collecting debris generated during a threading process. The middle section may have at least one aperture (11) through a circumference for allowing debris to be dispersed from the tool. The distal section may have at least one aperture (6) through the circumference for inserting a set screw (10) to secure the die in the tool.

### CROSS REFERENCE TO RELATED APPLICATIONS

This application claims the priority benefit of co-pending application Ser. No. 29/757971 having a filing date of Nov. 11, 2020.

### FIELD OF THE INVENTION

This invention relates to tools and more particularly a tool clean and resurface existing damaged threads on threaded items., such as wheel hubs, or to make threads on a bolt or other round object.

### BACKGROUND OF THE INVENTION

Threaded items, such as bolts on truck and other vehicle wheel hubs often become damaged or dirty during use, thereby making it difficult to rethread or reuse, sometimes even requiring the replacement of an entire wheel. Current rethreading tools do not work well with rethreading wheel hub bolt threads as such tools do not fit into small places and cannot be rotated easily to clean and resurface threads.

Thus, in view of the above problems a need exists for a threading tool that can be used in tight spaces and which can be easily rotated at desired speed to quickly and more efficiently resurface threaded objects.

### SUMMARY OF THE INVENTION

The primary object of the present invention is to provide a tool to resurface or clean threads on and threaded item.

Another object of the present invention is to provide such a tool that can be used in tight spaces.

An additional object of the present invention is to provide such a tool that can accept a tool room type cutting die for threading round surfaces.

An even further object of the present invention is to provide such a tool that can be used with standard spinning devices, such as hand drill or socket and ratchet, to produce necessary spinning action to resurface existing threads back to useable condition.

The present invention fulfills the above and other objects by providing an elongated rigid threading tool having three sections, a proximal section, a middle section and a distal section. The proximal section is capable of being secured in a device for rotating the tool. The distal section is cylindrically-shaped having an outer circumference and an inner circumference forming a cavity for inserting a thread-cutting die. The distal section may have at least one aperture for inserting a set screw to secure the thread-cutting die in the cavity. The middle section has an internal cavity connected to the cavity in the distal section for holding debris generated during a threading process. The middle section may have at least one aperture from the internal cavity through an outer surface of the middle section to allow debris generated during a threading process to be dispersed from the tool. The threading tool can be rotated by a hand drill, a ratchet wrench or any spinning device by inserting the proximal section within a spinning device for use in performing a threading or rethreading process.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of the threading and rethreading tool of the present invention;

FIG. 2 is a side plan view of the threading and rethreading tool of the present invention;

FIG. 3 is a distal end view of the threading and rethreading tool of the present invention holding a threading die;

FIG. 4 is a proximal end view of the threading and rethreading tool of the present invention;

FIG. 5 is a perspective view of the threading and rethreading tool of the present invention having a debris-disposing aperture; and

FIG. 6 is a perspective view of the threading and rethreading tool of the present invention having a debris-disposing aperture.

### DESCRIPTION OF THE PREFERRED EMBODIMENTS

For purposes of describing the preferred embodiment, the terminology used in reference to the numbered accessories in the drawings is as follows:
1. threading tool, generally
2. proximal section
3. distal section
4. middle section
5. inner circumference of die holding cavity
6. set screw aperture
7. threading die holding cavity
8. debris holding cavity
9. thread cutting die
10. set screws
11. debris apertures

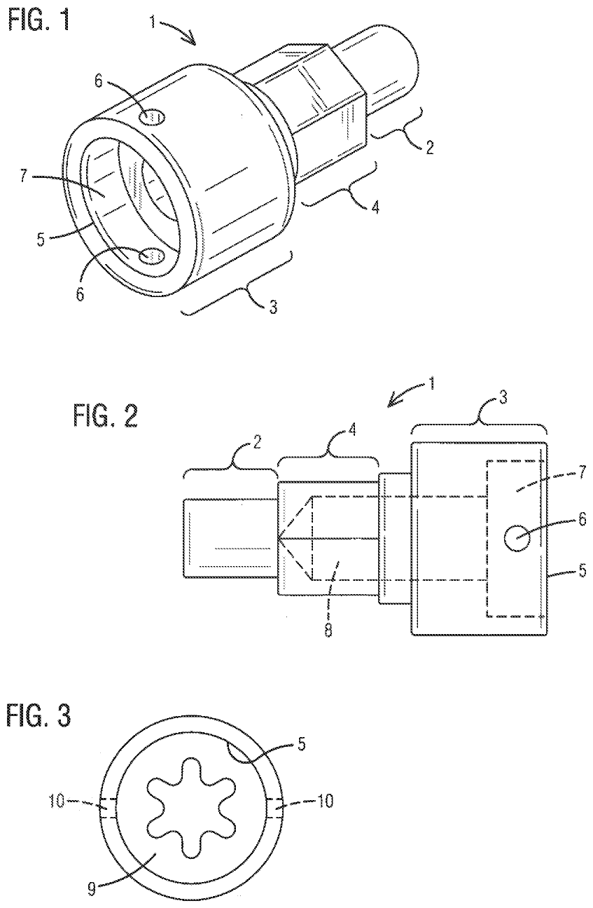

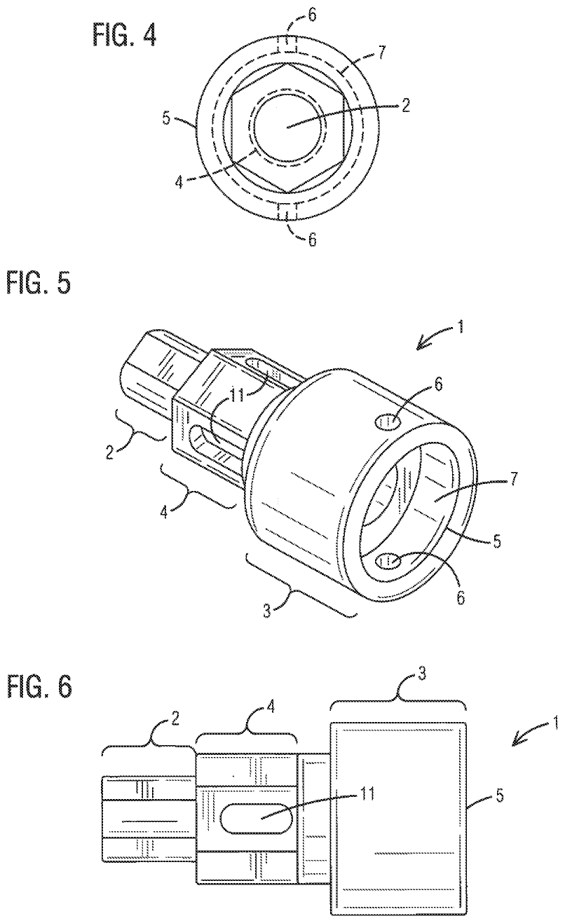

Discussing the preferred embodiments of the threading/rethreading tool of the present invention, reference is made to the drawings. FIGS. 1, 2 and 3 illustrate the threading/rethreading tool 1 in perspective, plan and end views, respectively. The tool 1 has three sections, a proximal section 2, a distal section 3 and a middle section 4. The distal section 3 has a cavity 7 having an inner circumference 5 for inserting and holding a thread cutting die 9 as illustrated in FIG. 3. The distal section 3 may have apertures 6 for inserting set screws 10 which can be rotatably tightened to securely hold the thread cutting die 9 in the tool during a threading/rethreading cutting. The middle section 4 contains an internal cavity 8 which is connected to the cavity 7 in the distal section 3, the purpose of which is to collect debris and hold generated during a threading/rethreading process. The proximal section 2 of the tool 1 as further illustrated in the end view of FIG. 4 may be circular, hexagonal or otherwise shaped to be inserting in a rotating or spinning device such as a handheld drill or socket wrench to perform the threading/rethreading process.

FIGS. 5 and 6 illustrate the threading/rethreading tool 1 described above further having at least one debris dispensing aperture 11 in the middle section 4 which allows excess debris and shavings generated during a threading/rethreading process to be dispersed from the tool 1. The threading/rethreading tool of the present invention may be made of rigid material, including without limitation metal or plastic.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. A threading tool comprising:
an elongated rigid tool having three sections, a proximal section, a middle section and a distal section;
said proximal section capable of being secured in a device for rotating the tool;
said distal section being cylindrically-shaped having an outer circumference and an inner circumference forming a cavity for inserting a thread-cutting die; and
said middle section having an internal to the cavity in the distal section for holding debris generated during a threading process.

2. The threading tool of claim 1 wherein the middle section further comprises:
at least one aperture from the internal cavity through an outer surface of the middle section to allow debris generated during a threading process to be dispersed from the tool.

3. The threading tool of claim 1 further comprising at least one aperture in the distal section for inserting a set screw to secure the thread-cutting die in the cavity

4. The threading tool of claim 1 wherein the device for rotating the tool is a hand drill.

5. The threading tool of claim 1 wherein the device for rotating the tool is a wrench.
